(19) United States
(12) Patent Application Publication
(10) Pub. No.: US 2015/0237951 A1
(43) Pub. Date: Aug. 27, 2015

(54) Grip-Enhancing Shoelace, Shoe Therefor, and Methods of Manufacturing the Same

(71) Applicant: Henry Lucius Hilderbrand, IV, Suwanee, GA (US)

(72) Inventor: Henry Lucius Hilderbrand, IV, Suwanee, GA (US)

(21) Appl. No.: 14/613,907

(22) Filed: Feb. 4, 2015

Related U.S. Application Data
(60) Provisional application No. 61/943,773, filed on Feb. 24, 2014.

(51) Int. Cl. A43B 5/02; B05D 1/28; B05D 1/02; A43C 9/00; B05D 1/18

(52) U.S. Cl. CPC A43B 5/02; A43C 9/00; B05D 1/18; B05D 1/02; B05D 1/28

(57) ABSTRACT

Shoelaces for increasing grip on a kicked ball, shoes therefor, and methods of manufacturing the same are provided. A shoelace includes a base material and a coating material disposed along at least a portion of the length of the shoelace base material and along at least a portion of a circumference of the shoelace base material, wherein the coating material includes a coating base material, or a coating base material and an aggregate material, that increases the coefficient of friction between the shoelace and the kicked ball.

### CROSS-REFERENCE TO RELATED APPLICATIONS

This application claims the benefit of U.S. Provisional Application No. 61/943,773, filed on Feb. 24, 2014, which is incorporated herein by reference in its entirety.

### BACKGROUND

The present disclosure relates generally to sportswear, and more particularly to grip-enhancing shoelaces and shoes therefor.

Various sports and activities, such as soccer, American football, rugby, Australian rules football, and kickball, involve an athlete kicking, dribbling, or controlling a ball with his or her feet. Footwear technology currently exists to aid the wearer in handling and controlling a ball. However, shoelaces and their location on most shoes can adversely affect an athlete's ability to handle and control the ball. With existing athletic shoes and laces, when an athlete kicks the ball and the point of impact occurs on the uneven and/or slippery surface of the shoelaces, the desired spin and control is not imparted to the ball.

Accordingly, there is a need for footwear and shoelaces to provide improved ball gripping, control, and handling.

### SUMMARY

In one aspect, a shoelace for increasing grip on a kicked ball is provided, including a shoelace base material having a length from about 24 to about 72 inches, a width from about ⅛ inch to about 1½ inches, and two opposed shoelace faces. The shoelace also includes a coating material disposed along at least a portion of the length of the shoelace base material and along at least a portion of a circumference of the shoelace base material. The coating material includes a coating base material, or a coating base material and an aggregate material, that increases the coefficient of friction between the shoelace and the kicked ball.

In another aspect, a method of manufacturing a shoelace for increasing grip on a kicked ball is provided, including (i) providing a shoelace base material having a length from about 24 to about 72 inches, a width from about ⅛ inch to about 1½ inches, and two opposed shoelace faces, and (ii) coating the shoelace base material with a coating material along at least a portion of the length of the shoelace base material and along at least a portion of a circumference of the shoelace base material. The coating material includes a coating base material, or a coating base material and an aggregate material, that increases the coefficient of friction between the shoelace and the kicked ball.

In yet another aspect, a shoe for disposing a grip-enhancing shoelace to contact a ball when kicked by a wearer is provided, including an upper configured to receive the wearer's foot and comprising a lacing portion for receiving a grip-enhancing shoelace. The lacing portion is disposed at least partially along a medial side of the upper such that a coating material of the grip-enhancing shoelace is positioned to contact a ball when kicked by the wearer.

### BRIEF DESCRIPTION OF THE DRAWINGS

FIG. 1 is a plan view showing one embodiment of a grip-enhancing shoelace.

FIG. 2 is a plan view showing one embodiment of a grip-enhancing shoelace.

FIG. 3 is a plan view showing one embodiment of a grip-enhancing shoelace.

FIG. 4 is a plan view showing one embodiment of a grip-enhancing shoelace.

FIG. 5 is a cross-sectional view showing one embodiment of a grip-enhancing shoelace.

FIG. 6 is a cross-sectional view showing one embodiment of a grip-enhancing shoelace.

FIG. 7 is a cross-sectional view showing one embodiment of a grip-enhancing shoelace.

FIG. 8 is a cross-sectional view showing one embodiment of a grip-enhancing shoelace.

FIG. 9 is a cross-sectional view showing one embodiment of a grip-enhancing shoelace.

FIG. 10 is a cross-sectional view showing one embodiment of a grip-enhancing shoelace.

FIG. 11 is a perspective view showing one embodiment of a shoe with medial offset lacing for a grip-enhancing shoelace.

### DETAILED DESCRIPTION

The present invention addresses one or more of the above-described needs by providing grip-enhancing shoelaces, shoes for grip-enhancing shoelaces, and methods of manufacturing the same. Several embodiments of shoelaces, shoes, and methods of making these articles are described herein. Parameters of different components, features, and steps of the embodiments are described separately, but may be combined consistently with this description to enable still other embodiments as will be understood by those skilled in the art.

The footwear and shoelaces described herein provide improved ball gripping and handling, so as to allow an athlete to impart the desired spin and control on the ball. Existing shoelaces and their location on most shoes are generally not designed to aid the wearer in handling or controlling a ball. Moreover, athletic footwear that has been designed to enhance ball control and grip typically suffers from one or more issues. For example, shoes having one or more tacky or friction-enhancing zones or regions on the shoe upper may still experience control issues when the ball is contacted by the shoelaces. Additionally, the shoe lacing region is traditionally located on the top on the shoe upper, an area that is often used to contact the ball during kicking. Shoes utilizing friction-enhancing contact zones may require relocation of the laces to the lateral side of the shoe, which may be undesirable for lace placement and function. Furthermore, the shoelaces of the present disclosure may, advantageously, be incorporated into an athlete's existing shoes to provide enhanced grip at the top of the shoe, as well as to limit the slippage and control issues experienced by typical shoes when a ball is contacted therewith.

Additionally, certain shoelaces having increased slip-resistance are known. For example, shoelaces having a slip-resistant yarn woven or braided into the lace, or shoelaces including friction enhancing features or materials are known. However, such shoelaces are generally designed to provide internal slip-resistance, i.e., to prevent the lace from coming untied after tying. In contrast, the present disclosure is directed to shoelaces designed to increase the friction between the lace and a foreign object (e.g., a kicked ball). For example, these grip-enhancing laces may provide increased friction on a kicked ball while still allowing for normal lace tying and untying. Moreover, methods of manufacturing the presently disclosed laces are advantageously simpler as compared to methods in which slip-resistant yarns are braided into the laces. For example, the current shoelaces may be manufactured using known shoelace base materials.

Furthermore, as described herein, the shoelaces may be used in combination with shoes that are designed to position the laces such that they are more likely to contact a kicked ball, i.e., to position the laces at the top and/or medial sides of the shoe. Such shoes advantageously provide increased friction-enhancing surface area at the common location of ball contact during kicking.

Grip-enhancing shoelaces, shoes therefor, and methods of manufacturing the same are described in more detail below.

Grip-Enhancing Shoelaces

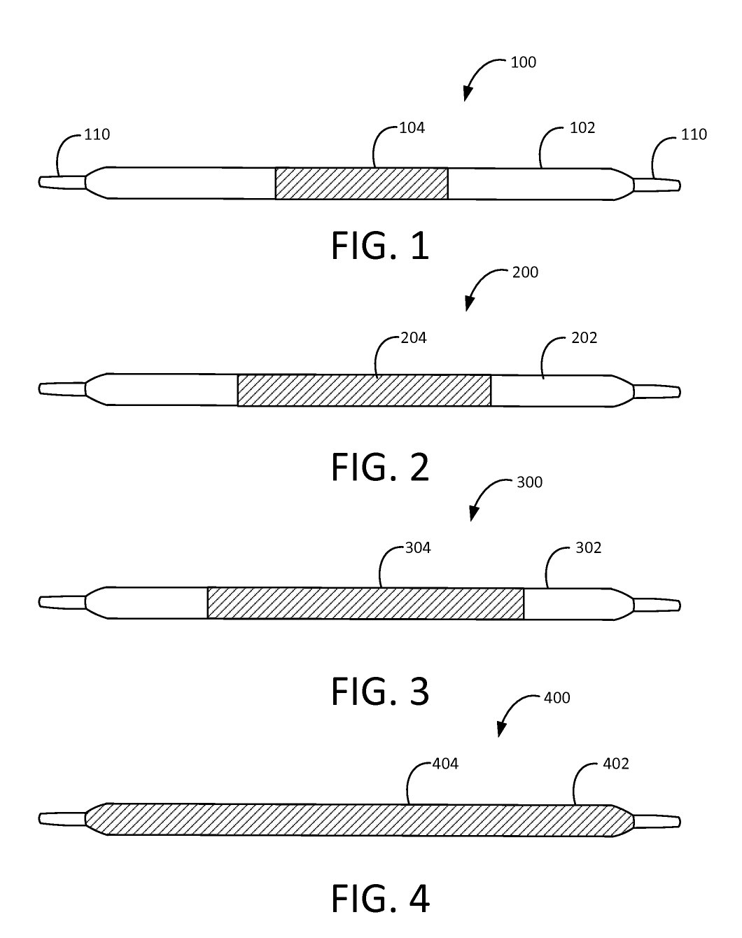

In certain embodiments, shoelaces for increasing grip on a kicked ball are provided. As shown in FIGS. 1-10, which are not drawn to scale, a shoelace may include a shoelace base material and a coating material disposed along at least a portion of the length of the shoelace base material and along at least a portion of a circumference of the shoelace base material. For example, as shown in FIG. 1, a shoelace 100 includes a base material 102 and a coating material 104 disposed along a portion of the length of the base material 102.

The shoelace base material may include any suitable material known to those of ordinary skill in the art. In one embodiment, the shoelace base material is selected from the group consisting of cotton, textured polyester, spun polyester, nylon, polypropylene, and combinations thereof. The shoelace based material may include any suitable materials known to those of ordinary skill in the art. As shown in FIG. 1, the shoelace 100 may include an aglet 110 at each end of the shoelace base material 102. In certain embodiments, the aglet is metal, plastic, or another suitable material.

The shoelace base material may have any suitable size and shape. In one embodiment, a shoelace has a length from about 24 to about 72 inches. In one embodiment, a shoelace has a width from about ⅛ inch to about 1½ inches. Other shoelace dimensions are also envisioned. In certain embodiments, the shoelace has a round, oval, or flat cross-sectional shape. For example, the shoelace may have a flat cross-section in which the lace has two opposed shoelace faces.

In certain embodiments, a coating material is disposed along at least a portion of the length of the shoelace material and along at least a portion of the circumference of the shoelace base material. In certain embodiments, the coating material includes one or both of a coating base material and an aggregate material. For example, the coating material may increase the coefficient of friction between the shoelace and a kicked ball.

The coating base material may include any suitable composition known to those of ordinary skill in the art. In one embodiment, the coating base material includes a natural or synthetic material selected from the group consisting of silicone, latex, and combinations thereof. For example, the coating base material may include a tacky or non-slip material. Suitable coating base materials may include roughened leathers, rubbers, silastics, or any elastomeric material such as styrene-butadiene, or polyurethane.

As used herein, the term “aggregate material” refers to particulate or granular material that can be combined with the coating material to impart additional coarseness or abrasiveness thereto. The aggregate material may include any suitable aggregate known to those of ordinary skill in the art. In one embodiment, the aggregate material includes a natural or synthetic material selected from the group consisting of garnet, emery, aluminum oxide, silicon dioxide, silicon carbide, and combinations thereof. In certain embodiments, suitable additives, dyes, and/or pigments are included in the coating material to achieve the desired aesthetic and performance properties, such as to achieve a desired coating color.

The amounts of base material and aggregate material used to form the coating material may vary based on the desired levels of tackiness and/or abrasiveness. In one embodiment, the coating material includes amounts of base material and aggregate material that are selected so as to increase the coefficient of friction between the shoelace to which it is applied and a kicked ball. For example, the coating material may include from about 10 to about 90 percent by weight of the coating base material and from about 10 to about 90 percent by weight of the aggregate material. In one embodiment, a coating material includes from about 40 to about 60 percent by weight of the coating base material and from about 40 to about 60 percent by weight of the aggregate material.

As shown in FIGS. 1-4, the shoelace base material may be coated along various lengths. As shown in FIG. 1, shoelace 100 includes coating material 104 along about 36 percent of the total length of the base material 102 (including any aglets). For example, the coating material may be disposed such that it is centered along the length of the shoelace. As shown in FIG. 2, shoelace 200 includes coating material 204 along about 44 percent of the total length of the base material 202. As shown in FIG. 3, shoelace 300 includes coating material 304 along about 60 percent of the total length of the base material 302. As shown in FIG. 4, shoelace 400 includes coating material 404 along the entire length of base material 402 (including or excluding the base material portion covered by any aglets).

In one embodiment, the coating material is disposed along a central portion of the length of the shoelace base material including from about 36 percent to about 44 percent of the length of the shoelace base material. In another embodiment, the coating material is disposed along a central portion of the length of the shoelace base material including from about 40 percent to about 60 percent of the length of the shoelace base material. For example, disposing the coating material along a centered portion of the base material advantageously leaves the end portions of the base material uncoated, which provides for unhindered lace tying.

In one embodiment, a shoelace includes a shoelace base material with a length of about 48 inches, with about 36 percent (approximately 17 inches) of the midsection of the shoelace base material being coated with a coating material. That is, approximately 8 inches on either side of the 24 inch base material midpoint would be coated, with approximately 15 inches from each aglet remaining uncoated.

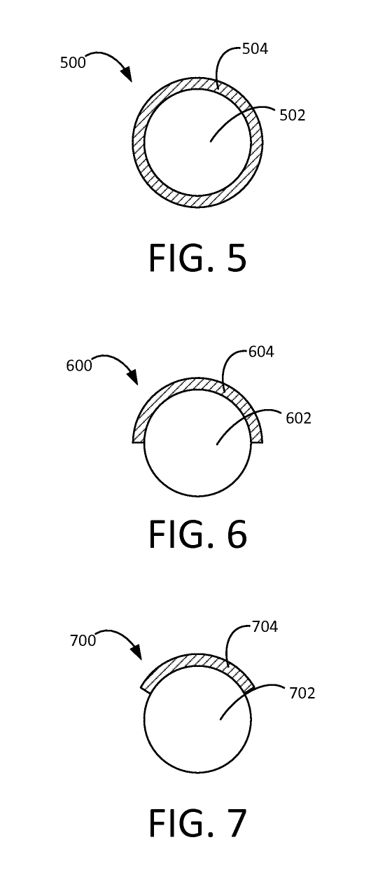

As shown in FIGS. 5-10, the shoelace base material may be coated along various circumferences of the base material. FIGS. 5-7 show shoelace base materials having a round cross-section. As shown in FIG. 5, shoelace 500 includes coating material 504 along the entire circumference of base material 502. As shown in FIG. 6, shoelace 600 includes coating material 604 along about 50 percent of the circumference of base material 602. As shown in FIG. 7, shoelace 700 includes coating material 704 along about 40 percent of the circumference of base material 702. For example, when only a portion of the circumference of the base material is coated, the shoelaces may be laced in a shoe such that the coated portion faces outward, i.e., the coated portion is positioned to contact a kicked ball, while providing minimal increased cross-sectional area of the shoelace.

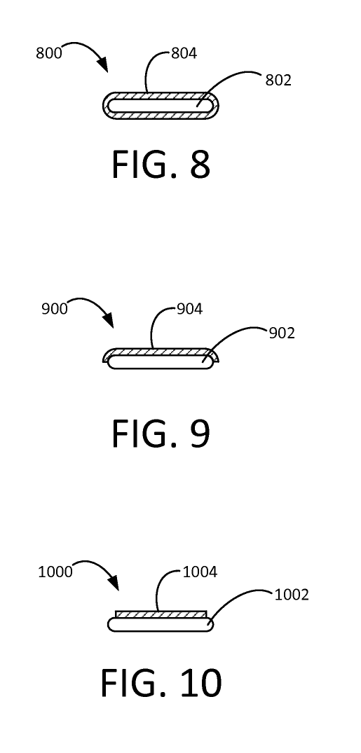

FIGS. 8-10 show shoelace base materials having a flat cross-section including two opposed shoelace faces. As shown in FIG. 8, shoelace 800 includes coating material 804 along the entire circumference of base material 802. As shown in FIG. 9, shoelace 900 includes coating material 904 along about 50 percent of the circumference of base material 902. As shown in FIG. 10, shoelace 1000 includes coating material 1004 along about 40 percent of the circumference of base material 1002. In FIG. 10, the coating material 1004 is disposed along a sole shoelace face of the shoelace base material 1002. For example, shoelaces having a flat cross-section may increase the coated surface area of the area contacted by a ball when kicked. Moreover, flat shoelaces may provide a level ball contact area, which may aid athlete control of the ball.

In one embodiment, the coating material is disposed along from about 40 percent to about 50 percent of the circumference of the shoelace base material.

In a particular embodiment, a shoelace for increasing grip on a kicked ball includes: (i) a shoelace base material having a length from about 24 to about 72 inches, a width from about ⅛ inch to about 1½ inches, and two opposed shoelace faces; and (ii) a coating material disposed along at least a portion of the length of the shoelace base material and along at least a portion of a circumference of the shoelace base material, wherein the coating material includes a coating base material, or a coating base material and an aggregate material, that increases the coefficient of friction between the shoelace and the kicked ball. The increased coefficient of friction between the shoelace and the kicked ball aids the athlete in imparting more spin or control on the ball being kicked. That is, the coating material may have a higher kinetic friction coefficient than the base material alone.

In one embodiment, the coating material includes a latex base material and an aluminum oxide aggregate material. In another embodiment, the coating material includes a silicone base material and an aluminum oxide aggregate material. In another embodiment, the coating material includes a latex base material and a silicon carbide aggregate material. In another embodiment, the coating material includes a silicone base material and a silicon carbide aggregate material. The coating material may be formulated to provide the desired abrasive, tacky, or non-slip properties, which may vary based on the sport, playing condition, and/or athlete position or technique. In certain embodiments, the coating materials may be designed to enhance gripping in the presence of moisture.

Methods of Manufacture

In certain embodiments, methods of manufacturing a shoelace for increasing grip on a kicked ball are provided. These methods may be designed to manufacture any embodiments of the shoelaces described herein.

In certain embodiments, methods of manufacturing a shoelace for increasing grip on a kicked ball include: (i) providing a shoelace base material, and (ii) coating the shoelace base material with a coating material along at least a portion of the length of the shoelace base material and along at least a portion of a circumference of the shoelace base material, to increase the coefficient of friction between the shoelace and the kicked ball. In one embodiment, the coating material includes a coating base material and an aggregate material.

For example, the shoelace base material may have any suitable size and shape, such as those described above with reference to the shoelaces.

Any suitable coating methods known to those of ordinary skill in the art may be used to coat the base material with the coating material. In certain embodiments, coating the shoelace base material with a coating material includes a coating method selected from the group consisting of: spraying, dipping, rolling, brushing, metering, screen printing, and combinations thereof. In certain embodiments, the coating material is applied in a single step (i.e., the coating base material and the aggregate are premixed and are applied in a single application). In other embodiments, the coating base material and the aggregate material are applied in sequential steps. In certain embodiments, the coating material is applied as a continuous strip. In other embodiments, at least a portion of the coating material is applied as a plurality of patterned or randomly located dots, stripes, or other coating geometries.

In certain embodiments, the methods further include curing the coating material. For example, the curing step may include heating, drying, chemical reaction or exposure to UV light.

In a particular embodiment, a method of manufacturing a shoelace for increasing grip on a kicked ball includes: (i) providing a shoelace base material having a length from about 24 to about 72 inches, a width from about ⅛ inch to about 1½ inch, and two opposed shoelace faces; and (ii) coating the shoelace base material with a coating material along at least a portion of the length of the shoelace base material and along at least a portion of a circumference of the shoelace base material, wherein the coating material includes a coating base material, or a coating base material and an aggregate material, that increases the coefficient of friction between the shoelace and the kicked ball.

For example, coating the shoelace base material with the coating material may include coating the shoelace base material along a central portion of the length of the shoelace base material including from about 36 percent to about 44 percent of the length of the shoelace base material. In one embodiment, coating the shoelace base material with the coating material includes coating the shoelace base material along a central portion of the length of the shoelace base material including from about 40 percent to about 60 percent of the length of the shoelace base material.

In one embodiment, coating the shoelace base material with the coating material includes coating the shoelace base material along from about 40 percent to about 50 percent of the circumference of the shoelace base material. For example, coating the shoelace base material with the coating material may include coating the shoelace base material along a sole shoelace face of the shoelace base material.

The coating material may be applied to the base material by one application process or by a combination of application methods. For example, the coating material may be applied by (i) direct spray and cure, (ii) dip and cure, (iii) roll and cure, (iv) brush and cure, (v) meter and cure and/or screen print and cure methods.

These methods advantageously provide for the manufacture of grip-enhancing shoelaces without requiring complex braiding or weaving operations. Moreover, these methods may utilize premade shoelace base materials.

Shoes for Grip-Enhancing Shoelaces

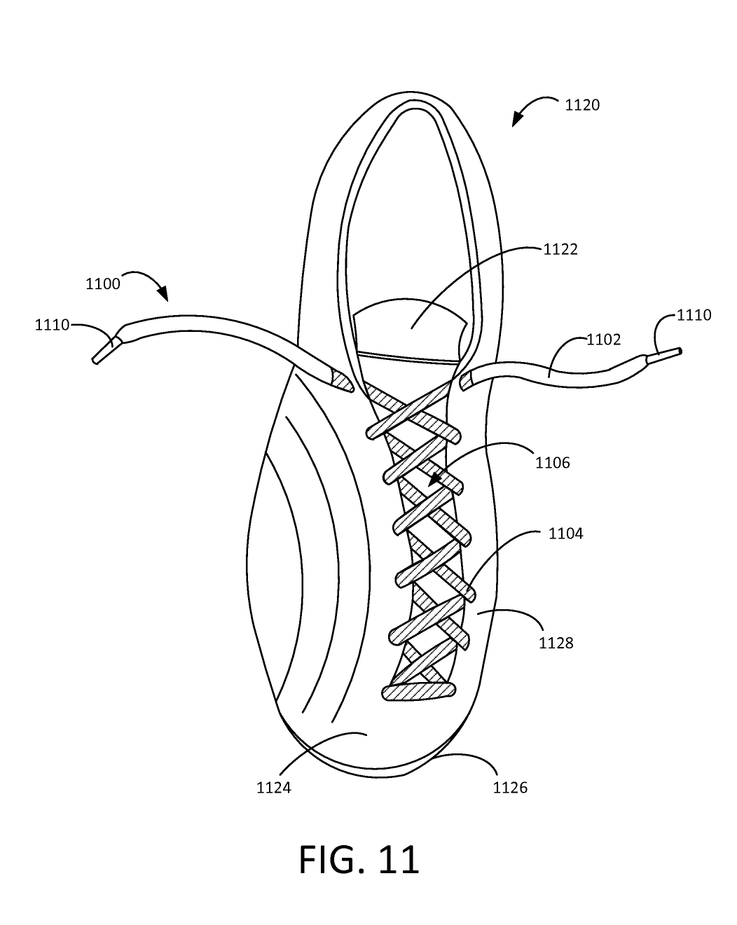

In certain embodiments, shoes for disposing a grip-enhancing shoelace to contact a ball when kicked by a wearer are provided. As shown in FIG. 11, which is not drawn to scale, shoe 1120 is designed to position grip-enhancing shoelace 1100 such that the shoelace contacts a ball when kicked by the wearer.

In certain embodiments, as shown in FIG. 11, a shoe 1120 for disposing a grip-enhancing shoelace 1100 to contact a ball when kicked by a wearer includes: (i) an upper 1124 configured to receive the wearer's foot and including a lacing portion 1106 for receiving a grip-enhancing shoelace 1100, wherein the lacing portion 1106 is disposed at least partially along a medial side 1128 of the upper 1124 such that a coating material 1104 of the grip-enhancing shoelace 1100 is positioned to contact a ball when kicked by the wearer. For example, the shoes may be configured to receive and position any embodiment of grip-enhancing shoelaces described herein.

The shoe may be any suitable athletic or other type of shoe that is configured to be fastened at least partially with a shoelace. For example, shoe 1120 includes sole 1126 that is attached to upper 1124. The sole may be made from any suitable material, such as elastomers, siloxanes, natural rubber, synthetic rubber, aluminum, steel, natural leather, synthetic leather, or plastics. The sole may also include elements, or attachments for elements, such as cleat studs or other traction elements that are designed to enhance traction with the ground.

The shoe upper may be associate with the sole and configured to receive a wearer's foot. For example, the upper may be made from any suitable material, such as nylon, natural leather, synthetic leather, natural rubber, or synthetic rubber. For example, the upper can be made of any suitable knitted, woven, or non-woven material. In one embodiment, the upper includes a material selected from a group consisting of nylon, leather, rubber, and combinations thereof.

In certain embodiments, the upper includes a lacing portion that may be used to tighten the upper to a wearer's foot. For example, the lacing portion may include any suitable configuration known to those of ordinary skill in the art, such as paired eyelets spaced along opposite sides of an elongated gap. In one embodiment, the lacing portion includes a plurality of eyelets for receiving the grip-enhancing shoelace therethrough.

In certain embodiments, as shown in FIG. 11, the lacing portion 1106 includes an elongated gap that extends substantially parallel to the longitudinal axis of the shoe 1120. For example, the elongated gap may extend along the top and medial sides of the upper, in the region of the shoe that contacts a ball being kicked by the wearer. In certain embodiments, the lacing portion 1106 may include one end that is substantially centered at the top of the upper (i.e., near the tongue 1122) and the other end that is positioned off-center on the medial side of the upper near the toe of the shoe. The lacing portion may have a slightly curved profile, for example a profile that follows the curvature of the shoe to position the shoelaces at the top/medial region of the foot for maximum contact of the shoelace to the ball while kicking. In one embodiment, the lacing portion is substantially longitudinally disposed along the medial side and a top side of the upper, such that the grip-enhancing shoelace is positioned to maximize a contact area of the grip-enhancing shoelace and a ball when kicked by the wearer.

That is, the lacing portion for receiving the grip-enhancing laces may be disposed over the region of the foot where the force transfer between the foot and a kicked ball is optimal, and where most athletes or wearers tend to kick a ball. Using this configuration, the shoe may provide enhanced gripping of a ball during kicking, allowing the user to easily apply spin to the ball in any direction.

In certain embodiments, the lacing portion of the shoe is configured to receive and position a shoelace including a coating material that includes a coating base material, or a coating base material and an aggregate material, that, increases the coefficient of friction between the shoelace and the kicked ball. In one embodiment, the lacing portion is configured to accommodate a grip-enhancing shoelace including: (i) a shoelace base material having a length from about 24 to about 72 inches and a width from about ⅛ inch to about 1½ inches; and (ii) a coating material disposed along at least a portion of the length of the shoelace base material and along at least a portion of a circumference of the shoelace base material, wherein the coating material includes a coating base material, or a coating base material and an aggregate material.

The lacing portion may be configured to receive shoelaces having any suitable size and shape. For example, the lacing portion is configured to accommodate a grip-enhancing shoelace with a flat cross-section having two opposed shoelace faces. In one embodiment, the lacing portion is configured to accommodate a shoelace in which a coating material is disposed along a sole shoelace face of the shoelace base material. For example, the lacing portion may be configured such that a flat shoelace may be laced therethrough so as to provide a flat, or level, grip-enhancing surface area for ball contact. In one embodiment, the lacing portion is configured to accommodate a grip-enhancing shoelace having a circular or oval-shaped cross-section.

For example, the lacing portion may be disposed on the upper in a manner that maximizes the contact area between the grip-enhancing shoelaces and a ball. This large contact area may facilitate friction between the shoe and a kicked ball, allowing for improved ball handling and control.

In certain embodiments, as shown in FIG. 11, the coating material 1104 is disposed along a central portion of the length of the shoelace base material 1102 including from about 40 percent to about 60 percent of the length of the shoelace base material 1102. For example, this partial-length coating allows the end portions of the shoelace base material 1102 (i.e., the portions near aglets 1110) to be uncoated, such that the lace may be tied in a normal manner. In one embodiment, the coating material is disposed along a central portion of the length of the shoelace base material including from about 36 percent to about 44 percent of the length of the shoelace base material.

In one embodiment, the coating material is disposed along from about 40 percent to about 50 percent of the circumference of the shoelace base material. For example, the shoelace may be positioned in the lacing portion of the shoe such that the coating material is facing outward, so as to contact a kicked ball.

In order to achieve better contact with the ball, and in some cases, apply some curvature in the trajectory of the kick, it may be necessary for the kicker to apply some spin to the ball. Accordingly, shoes for use with grip-enhancing laces may enhance the ability of the wearer to contact and control the ball when kicked. Specifically, the shoes described herein are designed to position the laces such that they contact a kicked ball, i.e., to position the laces at the top and/or medial sides of the shoe. Such shoes advantageously provide increased friction-enhancing surface area at the typical location of ball contact during kicking without requiring relocation of the lacing portion to an undesirable region of the shoe.

For example, these shoes may be designed such that the shoelaces, which may have a higher coefficient of friction than the upper or other portions of the shoe, are positioned to make initial contact with a ball before the surface of the upper.

In certain embodiments, the lacing portion is configured to provide an even, symmetric, and/or level contact area between the ball and the shoe. Even distribution of the contact area may provide the wearer of the shoe with the ability to firmly and positively contact a kicked ball. The shoes described herein may provide an athlete with a firm and predictable contact area and grip, as compared to known equipment that may cause unpredictable deflection of a ball during kicking.

It will be appreciated that various above-disclosed and other features and functions, or alternatives thereof, may be desirably combined into many other different products or applications. Various presently unforeseen or unanticipated alternatives, modifications, variations, or improvements therein may be subsequently made by those skilled in the art which are also intended to be encompassed by the following claims.

What is claimed is:

1. A shoelace for increasing grip on a kicked ball, comprising:
a shoelace base material having a length from about 24 to about 72 inches, a width from about ⅛ inch to about 1½ inches, and two opposed shoelace faces; and
a coating material disposed along at least a portion of the length of the shoelace base material and along at least a portion of a circumference of the shoelace base material,
wherein the coating material comprises a coating base material, or a coating base material and an aggregate material, that increases the coefficient of friction between the shoelace and the kicked ball.

2. The shoelace of claim 1, wherein the coating base material is selected from the group consisting of silicone, latex, and combinations thereof.

3. The shoelace of claim 1, wherein the aggregate material comprises a natural or synthetic material selected from the group consisting of garnet, emery, aluminum oxide, silicon dioxide, silicon carbide, and combinations thereof.

4. The shoelace of claim 1, wherein the coating material is disposed along a central portion of the length of the shoelace base material comprising from about 36 percent to about 44 percent of the length of the shoelace base material.

5. The shoelace of claim 1, wherein the coating material is disposed along a central portion of the length of the shoelace base material comprising from about 40 percent to about 60 percent of the length of the shoelace base material.

6. The shoelace of claim 1, wherein the coating material is disposed along from about 40 percent to about 50 percent of the circumference of the shoelace base material.

7. The shoelace of claim 6, wherein the coating material is disposed along a sole shoelace face of the shoelace base material.

8. A method of manufacturing a shoelace for increasing grip on a kicked ball, comprising:
providing a shoelace base material having a length from about 24 to about 72 inches, a width from about ⅛ inch to about 1½ inches, and two opposed shoelace faces; and
coating the shoelace base material with a coating material along at least a portion of the length of the shoelace base material and along at least a portion of a circumference of the shoelace base material,
wherein the coating material comprises a coating base material, or a coating base material and an aggregate material, that increases the coefficient of friction between the shoelace and the kicked ball.

9. The method of claim 8, wherein coating the shoelace base material with the coating material comprises coating the shoelace base material along a central portion of the length of the shoelace base material comprising from about 36 percent to about 44 percent of the length of the shoelace base material.

10. The method of claim 8, wherein coating the shoelace base material with the coating material comprises coating the shoelace base material along a central portion of the length of the shoelace base material comprising from about 40 percent to about 60 percent of the length of the shoelace base material.

11. The method of claim 8, wherein coating the shoelace base material with the coating material comprises coating the shoelace base material along from about 40 percent to about 50 percent of the circumference of the shoelace base material.

12. The method of claim 11, wherein coating the shoelace base material with the coating material comprises coating the shoelace base material along a sole shoelace face of the shoelace base material.

13. The method of claim 8, wherein coating the shoelace base material with a coating material comprises a coating method selected from the group consisting of: spraying, dipping, rolling, brushing, metering, screen printing, and combinations thereof.

14. The method of claim 8, further comprising curing the coating material.

15. A shoe for disposing a grip-enhancing shoelace to contact a ball when kicked by a wearer, the shoe comprising:
an upper configured to receive the wearer's foot and comprising a lacing portion for receiving a grip-enhancing shoelace,
wherein the lacing portion is disposed at least partially along a medial side of the upper such that a coating material of the grip-enhancing shoelace is positioned to contact a ball when kicked by the wearer.

16. The shoe of claim 15, wherein the lacing portion is substantially longitudinally disposed along the medial side and a top side of the upper, such that the grip-enhancing shoelace is positioned to maximize a contact area of the grip-enhancing shoelace and a ball when kicked by the wearer.

17. The shoe of claim 15, wherein the lacing portion comprises an elongated gap that extends substantially parallel to a longitudinal axis of the shoe.

18. The shoe of claim 17, wherein the elongated gap extends along a top side and the medial side of the upper, in a region of the shoe that contacts the ball being kicked by the wearer.

19. The shoe of claim 15, wherein the lacing portion comprises:
a first end that is substantially centered along a longitudinal axis of the shoe proximate a tongue at a top side of the upper, and
a second end that is offset from the longitudinal axis on the medial side of the upper proximate a toe of the shoe.

20. The shoe of claim 15, wherein the lacing portion has a curved profile that follows a curvature of the shoe to position the shoelaces at a region for maximum contact of the shoelace to the ball while kicking.
